(19) United States
(12) Patent Application Publication
(10) Pub. No.: US 2006/0134419 A1
(43) Pub. Date: Jun. 22, 2006

(54) Use of polyarylene ether ketone powder in a three-dimensional powder-based moldless production process, and moldings produced therefrom

(75) Inventors: Sylvia Monsheimer, Haltern am See (DE); Maik Grebe, Bochum (DE); Alexander Richter, Recklinghausen (DE); Patrick Kreidler, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/293,360

(22) Filed: Dec. 5, 2005

(30) Foreign Application Priority Data
Dec. 21, 2004 (DE) 102004062761.4

(51) Int. Cl. C08G 8/02; B32B 15/02

(52) U.S. Cl. 428/402; 264/497; 264/492; 264/489; 528/125

(57) ABSTRACT

A polymer powder containing polyarylene ether ketone and having a BET surface area of from 1 to 60 m²/g is suitable for use in a layer-by-layer process in which regions of a powder layer are selectively melted via introduction of electromagnetic energy.

### BACKGROUND OF THE INVENTION

1. Field of the Invention

The present invention relates to a powder containing a porous polyarylene ether ketone (PAEK) whose BET surface area is from 1 to 60 m²/g, to the use of the powder in a layer-by-layer process in which regions of a pulverulent layer are selectively melted via introduction of electromagnetic energy, and to moldings produced by this process.

2. Description of the Related Art

Rapid production of prototypes is a task frequently encountered in very recent times. Particularly suitable processes are those whose operation is based on pulverulent materials and in which the desired structures are produced layer-by-layer via selective melting and hardening. However, the processes are also suitable for short-run production.

The porous polyarylene ether ketone (PAEK) is generally prepared via reaction of an aromatic dihalogen compound with a bisphenol and/or of a halophenol in the presence of alkali metal carbonate or alkaline earth metal carbonate or alkali metal hydrogen carbonate or alkaline earth metal hydrogen carbonate in a high-boiling aprotic solvent to give a PAEK, discharge and solidification of the melt, if appropriate milling, e.g. in a hammer mill, extraction of the resultant particles with one or more organic solvents in order to remove the reaction solvent, and with water in order to remove the inorganic salts, and subsequent drying. The particles for extraction can be produced from the reaction mixture not only via milling but also via pelletization of an extruded strand, application of droplets to a cooled metal belt, prilling, or spray drying. The degree of porosity obtained after extraction depends in particular upon the content of reaction solvent in the product prior to extraction. To this extent, it is advantageous to remove only a portion of the reaction solvent during spray drying. In other respects the manner of production of the particles for extraction is non-critical.

The preparation process for PAEK with subsequent extraction has been described in many patent applications, such as EP-A-0 001 879, EP-A-0 182 648, EP-A-0 244 167, and EP-A-0 322 151.

### SUMMARY OF THE INVENTION

It is an object of the present invention to provide a polymer powder for use in three-dimensional processes which exhibits high heat resistance.

It is another object of the present invention to provide a polymer powder which is suitable for selective melting of pulverulent material which was applied layer-by-layer to form a three-dimensional structure after cooling.

It is yet another object of the present invention to provide a polymer powder which has a high BET surface area.

This and other objects have been achieved by the present invention the first embodiment of which includes A polymer powder, comprising:

polyarylene ether ketone;

wherein said powder has a BET surface area of from 1 to 60 m²/g; and

wherein said powder is suitable for use in a layer-by-layer process in which regions of a powder layer are selectively melted via introduction of electromagnetic energy.

In another embodiment, the present invention relates to a process for the preparation of the above polymer powder.

The present invention also related to a process for production of a molding, comprising:

selectively melting regions of a layer of the above polymer powder via introduction of electromagnetic energy.

The present invention relates to a molding obtained by the above process.

### DETAILED DESCRIPTION OF THE INVENTION

For the purposes of the present invention it is also possible that a PAEK which may have been prepared by another process (other than those described in EP-A-0 001 879, EP-A-0 182 648, EP-A-0 244 167, and EP-A-0 322 151) and has compact form, e.g. that of a pellet, is dissolved in a suitable high-boiling aprotic solvent, whereupon the hot solution is, as described above for the melt obtained during the reaction, converted into particle form and extracted with one or more organic solvents.

The high-boiling aprotic solvent is preferably a compound of the formula 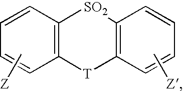
where T is a direct bond, an oxygen atom, or two hydrogen atoms; Z and Z′ are hydrogen or phenyl groups. Diphenyl sulfone is preferred here.

The PAEK contains units of the formulae
(—Ar—X—) and (—Ar′—Y—),
wherein Ar and Ar′ are a divalent aromatic radical, preferably 1,4-phenylene, 4,4′-biphenylene, or else 1,4-, 1,5-, or 2,6-naphthylene, X is an electron-withdrawing group, preferably carbonyl or sulfonyl, Y is a group such as O, S, CH₂, isopropylidene, or the like. At least 50%, preferably at least 70%, and particularly preferably at least 80%, of the groups X should be a carbonyl group, whereas at least 50%, preferably at least 70%, and particularly preferably at least 80%, of the groups Y should comprise oxygen.

In a particularly preferred embodiment, 100% of the groups X are carbonyl groups and 100% of the groups Y are oxygen. In this embodiment, the PAEK can by way of example be a polyether ether ketone (PEEK; formula I), a polyether ketone (PEK; formula II), a polyether ketone ketone (PEKK; formula III), or a polyether ether ketone ketone (PEEKK; formula IV), but other arrangements of the carbonyl groups and oxygen groups are, of course, also possible.

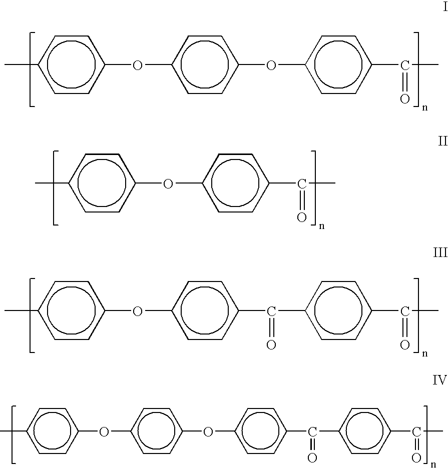

The PAEK is generally semicrystalline, and this is seen by way of example in the DSC analysis via presence of a crystallite melting point Tₘ which in most cases has an order of magnitude of 300° C. or higher. However, the present invention is also applicable to amorphous PAEK. As a general rule, sulfonyl groups, biphenylene groups, naphthylene groups, or bulky groups Y, e.g. an isopropylidene group, reduce crystallinity.

In one preferred embodiment, the viscosity number measured to DIN EN ISO 307 on a solution of 250 mg of PAEK in 50 ml of 96% strength by weight H₂SO₄ at 25° C. is from about 20 to 150 cm³/g, and preferably from 50 to 120 cm³/g.

The BET surface area is determined to DIN ISO 66131.

The porous PAEK can be ground at room temperature or at an elevated temperature, but in order to improve the grinding process and the milling yield it is advantageous to grind at a relatively low temperature, preferably below 0° C., particularly preferably below −20° C., and with particular preference below −40° C. Among suitable grinding equipment are pinned-disk mills, fluidized-bed opposed-jet mills, or baffle-plate impact mills. The porous structure of the PAEK prior to milling provides weak sites which lead to fracture under the abovementioned conditions.

The ground product can be subsequently sifted or sieved. Depending on the ground product used and on the subsequent separation method, it is possible to prepare a fine PAEK powder suitable for the process of the present invention with a numeric median particle diameter (d₅₀) of from 30 to 150 μm, preferably from 45 to 120 μm, particularly preferably from 48 to 100 μm. The d₅₀ includes all values and subvalues therebetween, especially including 40, 50, 60, 70, 80, 90, 100, 110, 120, 130, and 140 μm.

The particle diameters and their distribution are determined via laser diffraction to DIN ISO 13320-1.

Processes particularly suitable for production of the moldings of the present invention are those whose operation is based on pulverulent thermoplastic materials and in which the desired structures are produced layer-by-layer via selective melting and hardening. Preferably, no support structures are needed here for overhangs and undercuts, because the powder bed surrounding the melted regions provides sufficient support. Preferably, there is no need for any subsequent work for removing supports. The processes are also suitable for short-run production.

The present invention provides a process for use of a powder based on PAEK, and also moldings produced via a layer-by-layer process by which regions of a layer are selectively melted via introduction of electromagnetic energy, using this powder. The melted regions harden on cooling and thus form the desired molding. Excess powder material is removed.

One process which has particularly good suitability for the purposes of rapid prototyping or rapid manufacturing is laser sintering. In this process, plastics powders are selectively and briefly irradiated by a laser beam in a chamber, the result being that the powder particles impacted by the laser beam are melted. The melted particles coalesce and solidify after cooling to give a solid mass. Repeated irradiation of a succession of freshly applied layers can produce complex three-dimensional products by this process in a simple and rapid manner.

However, there are many other suitable processes alongside laser sintering. The selectivity of the layer-by-layer processes can be achieved by way of application of susceptors, of absorber, or of inhibitors, or via masks, or by way of focused introduction of energy, for example via a laser beam or via a glass fiber cable.

Some processes which can be used to produce moldings of the present invention from the powder of the present invention are described below, but there is no intention to restrict the present invention thereto.

The laser sintering (rapid prototyping) process for production of moldings from pulverulent polymers is described in detail in the patent specifications U.S. Pat. No. 6,136,948 and WO 96/06881 (both DTM Corporation). A wide variety of polymers and copolymers is claimed for this application, examples being polyacetate, polypropylene, polyethylene, ionomers, and nylon-11.

The laser-sintering process produces a block-like product which is composed firstly of the desired components and secondly, and mostly predominantly, of unirradiated powder, termed recycling powder, which remains within this block with the components until demolded or unwrapped. It acts to support the components, thus permitting production of overhangs and undercuts by the laser-sintering process without support structures. The unirradiated powder can, if it is of appropriate type, be used in a further construction process after sieving and addition of virgin powder (recycling).

Other processes with good suitability are the SIB process as described in WO 01/38061, or a process as described in EP 1 015 214. Both processes operate with infrared heating to melt the powder. The selectivity of melting is achieved in the first process via application of an inhibitor and in the second process via a mask. DE 103 11 438 describes another process. In this, the energy needed for fusion is introduced via a microwave generator, and selectivity is achieved via application of a susceptor. Other suitable processes are that which use an absorber, which is either present within the powder or is applied by ink-jet methods, as described in DE 102004012682.8, DE 102004012683.6, and DE 102004020452.7. A wide range of lasers can be used here to provide the electromagnetic energy, but another suitable method is provision of the electromagnetic energy over an area.

“Selective Laser Sintering of Nylon 12-Peek Blends formed by cryogenic mechanical alloying” by J. P. Schultz, J. P. Martin, R. G. Kander, published in Solid Freeform Fabrication Proceedings 2000, pages 119-124, describes a blend comprising nylon-12 and PEEK, describing a mechanical blending process at low temperatures where both components are present in powder form. At this stage the difficulty of producing a dense component by laser-sintering with the blend becomes apparent.

A disadvantage of the related art is that there has hitherto been no commercial availability of any high-heat-resistance material for use in a three-dimensional process in which pulverulent material applied layer-by-layer is selectively melted with the aid of electromagnetic radiation and, after cooling, forms the desired three-dimensional structure. The reason for this is firstly the difficulty of producing a sufficiently fine powder. Sufficiently fine means that the desired degree of resolution of the components is achieved, and at the same time the layer thickness is sufficiently small to permit the amount of energy introduced selectively to ensure the melting of a layer. The range from 30 to 150 μm may be mentioned as an example of the median grain diameter of a powder for use in one of the processes described. Yields of less than 10% in the grinding process cannot generally be regarded as commercially useful. Another factor is that the temperatures at which particularly the high-heat-resistance materials are processed are very high and it is therefore difficult or impossible to process these materials in the rapid prototyping/rapid manufacturing machines found in the market. Another cause, alongside the high melting point, is the very low BET surface areas of PAEK powder of the related art, these leading to impaired energy absorption by the particle to be melted.

Surprisingly, it has now been found, that a powder according to the present invention as described above can be used as fundamental material for use in the three-dimensional processes described. The parts produced using this powder have higher mechanical strength and higher heat resistance than components composed of, for example, the standard material EOSINT P2200 (supplied by EOS GmbH, Krailling, Germany) or DURAFORM (supplied by 3D Systems, Valencia, Calif.) currently available for laser sintering. The material is preferably optimized in relation to grain size distribution and used with addition of a powder-flow aid. It can also be advantageous for the particles featuring sharp edges from the milling process to undergo subsequent rounding via mechanical action, for example in a high-speed mixer. It is particularly preferable that a IR absorber is added to the powder regions to be melted, and by way of example this may be present by this stage within the powder, or may be added during processing via application of the absorber by ink-jet methods or by broadcasting or spray methods to the regions to be melted.

The fundamental material is a milled powder based on PAEK (polyarylene ether ketone). It is characterized by the grinding of PAEK particles whose BET surface area is at least 1 m²/g. This material may preferably be PEEK, PEK, PEKK, or PEEKK. The median grain diameter d₅₀ for use in a three-dimensional process which operates on the basis of pulverulent thermoplastic materials and in which the desired structures are produced layer-by-layer via selective melting and hardening is from 30 to 150 μm, preferably from 45 to 120 μm, and very particularly preferably from 48 to 100 μm. For better processability in a rapid prototyping/rapid manufacturing system, the fraction of particles smaller than 30 μm can, for example, be reduced via sifting. It can also be useful to remove particles which are larger, or only slightly smaller, than the layer thickness set in the process, e.g. with the aid of a sieving process. The grain size distribution of the powder of the present invention used in the RP/RM process here can be narrow, broad, or else bimodal.

The BET surface area of the PAEK powder which serves as a basis for the present invention is from 1 m²/g to 60 m²/g, preferably from 5 m²/g to 45 m²/g, and particularly preferably from 15 m²/g to 40 m²/g. The BET surface area includes all values and subvalues therebetween, especially including 5, 10, 15, 20, 25, 30, 35, 40, 45, 50 and 55 m²/g. The large surface area leads to better and more uniform absorption of the electromagnetic energy needed for selective melting of regions of a powder layer. In the inverse sense, that means that operations can use less energy when the powder of the present invention is used, and the components are more dimensionally accurate because the smaller amount of energy introduced reduces the amount of heat conducted into surrounding regions. Particular problems substantially eliminated are those of “round corners” or enlargement of components in regions where a large amount of heat is introduced. This effect is not achieved with PAEK powders of the related art whose BET surface areas are less than 1 m²/g. The crystallite melting point of the powder of the present invention depends on the type of PAEK used; it is above 300° C.

Another requirement of processing in a rapid prototyping/rapid manufacturing system, for purposes of automated powder feed, and metering and application of a thin powder layer, is that the powders used have to have sufficient free flow. To this end, it is advisable to admix a powder-flow aid, for example fumed silicon dioxide. Typical amounts of powder-flow aid are from 0.01 to 10%, based on the polymer present in the composition. The amount of powder-flow aid includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5 wt %.

In order, on the one hand, to ensure sufficient flowability of the PAEK selectively melted via the electromagnetic energy, so that, if appropriate, bonding to the layer situated there under is achieved and production of components is possible with minimum cavitation, and also, on the other hand, to achieve good mechanical strength of the components, the preferred solution viscosity ranges from 0.2 to 1.3, particularly preferably from 0.5 to 1.1. The solution viscosity includes all values and subvalues therebetween, especially including 0.3, 0.4, 0.5, 0.6, 0.7, 0.8, 0.9, 1, 1.1, and 1.2. The solution viscosity is determined on the PAEK here to EN ISO 1628-1, or by a method based on DIN EN ISO 307 in 96% strength sulfuric acid. It is moreover advantageous that molecular weight is at least retained during processing in a rapid prototyping/rapid manufacturing system, and a rise in molecular weight can be regarded as particularly preferred.

A further advantageous modification of the PAEK powder consists in incorporation of a suitable absorber. The absorber can either have uniform distribution within the particle, or have high concentration in the interior or close to the surface.

The absorber, particularly IR absorber, may be colorant or other additives. Examples of these are carbon black, CHP (copper hydroxide phosphate), animal charcoal, flame retardant based on melamine cyanurate or phosphorus, carbon fibers, chalk, graphite, or predominantly transparent powders, e.g. interference pigments and CLEARWELD® (WO 0238677), but there is no intention to restrict the present invention thereto. There are very many ways of modifying the PAEK powder.

The present invention therefore also provides a process for modification of PAEK powder, which comprises producing a pulverulent mixture of the PAEK powder of the present invention and an appropriate absorber.

The powder of the present invention preferably comprises, based on the entirety of the polymers present in the powder, from 0.01 to 30% by weight of an absorber, preferably from 0.05 to 20% by weight of an absorber, particularly preferably from 0.2 to 15% by weight of an absorber, and very particularly preferably from 0.4 to 10% by weight of an absorber. The amount of absorber includes all values and subvalues therebetween, especially including 0.05, 0.1, 0.5, 1, 5, 10, 15, 20, and 25 wt %. The ranges stated here are based on the total content within the powder of an absorber capable of excitation via electromagnetic energy, and powder here means the entire amount comprising components.

The powder of the present invention can comprise a mixture of an absorber and polymer particles, or else comprise polymer particles or polymer powder which comprise incorporated absorber. If the content of the absorber is below 0.01% by weight, based on the entire amount comprising components, the desired effect of improved meltability of the entire composition via electromagnetic radiation reduces markedly. If the content of the absorber is above 30% by weight, based on the entire composition comprising components, the mechanical properties become impaired, e.g. the tensile strain at break of moldings produced from such powders becomes markedly impaired, and processability suffers.

The particle size of the absorber is preferably below the median grain size d₅₀ of the polymer particles or polymer powders by at least 20%, preferably by more than 50% and very particularly preferably by more than 70%. The median particle size of the absorber is in particular from 0.001 to 50 μm, preferably from 0.02 to 10 μm. The median particle size includes all values and subvalues therebetween, especially including 0.005, 0.01, 0.05, 0.1, 0.5, 1, 5, 10, 15, 20, 25, 30, 35, 40, and 45 μm. The small particle size gives good distribution of the pulverulent absorber within the pulverulent polymer.

In the simplest case, the absorber comprises what is known as a colorant. A colorant means any of the colorant substances to DIN 55944 which are divisible into inorganic and organic colorants, and also into natural and synthetic colorants (see Römpps Chemielexikon [Römpp's Chemical Encyclopedia], 1981, 8ₜₕ edition, p. 1237). According to DIN 55943 (September 1984) and DIN 55945 (August 1983), a pigment is an inorganic or organic colorant whose color is non-neutral or neutral and which is practically insoluble in the medium in which it is used. Dyes are inorganic or organic colorants whose color is non-neutral or neutral and which are soluble in solvents and/or in binders.

However, the absorber may also gain its absorbent action by comprising additives. By way of example, these may be flame retardants based on melamine cyanurate (MELAPUR from DSM) or based on phosphorus, preference being given to phosphates, phosphites, phosphonites, or elemental red phosphorus. Other suitable additives are carbon fibers, preferably ground, glass beads, including hollow beads, or kaolin, chalk, wollastonite, or graphite.

The absorber present in the powder of the present invention preferably comprises carbon black or CHP (copper hydroxide phosphate), or chalk, animal charcoal, carbon fibers, graphite, flame retardant, or interference pigments as principal component. Interference pigments are what are known as pearl-luster pigments. Using the natural mineral mica as a basis, they are encapsulated with a thin layer comprising metal oxides, such as titanium dioxide and/or iron oxide, and are available with a median grain size distribution of from 1 to 60 μm. The median grain size distribution includes all values and subvalues therebetween, especially including 5, 10, 15, 20, 25, 30, 35, 40, 45, 50 and 55 μm. By way of example, interference pigments are supplied by Merck with the name IRIODIN. The IRIODIN product line from Merck encompasses pearl-luster pigments and metal-oxide-coated mica pigments, and also the subclasses of: interference pigments, metallic-luster special-effect pigments (iron oxide coating on the mica core), silver special-effect pigments, gold-luster special-effect pigments (mica core coated with titanium dioxide and with iron oxide). The use of IRIODIN grades in the IRIODIN LS series is particularly preferred, namely IRIODIN LS 820, IRIODIN LS 825, IRIODIN LS 830, IRIODIN LS 835, and IRIODIN LS 850. The use of IRIODIN LS 820 and IRIODIN LS 825 is very particularly preferred.

Other suitable materials are: mica or mica pigments, titanium dioxide, kaolin, organic and inorganic color pigments, antimony(III) oxide, metal pigments, pigments based on bismuth oxychloride (e.g. the BIFLAIR series from Merck, high-luster pigment), indium tin oxide (nano-ITO powder from Nanogate Technologies GmbH or ADNANO™ ITO from Degussa), ADNANO™ ZINC OXIDE (Degussa), lanthanum hexachloride, CLEARWELD® (WO 0238677), and also commercially available flame retardants which comprise melamine cyanurate or comprise phosphorus, preferably comprising phosphates, phosphites, phosphonites, or elemental (red) phosphorus.

If the intention is to avoid any adverse effect on the intrinsic color of the powder, the absorber preferably comprises interference pigments, particularly preferably from the IRIODIN LS series from Merck, or CLEARWELD®.

The chemical term for CHP is copper hydroxide phosphate; this is used in the form of a pale green, fine crystalline powder whose median grain diameter is just 3 μm.

The carbon black may be prepared by the furnace black process, the gas black process, or the flame black process, preferably by the furnace black process. The primary particle size is from 10 to 100 nm, preferably from 20 to 60 nm, and the grain size distribution may be narrow or broad. The BET surface area to DIN 53601 is from 10 to 600 m²/g, preferably from 70 to 400 m²/g. The primary particle size includes all values and subvalues therebetween, especially including 20, 30, 40, 50, 60, 70, 80 and 90 nm. The BET surface area includes all values and subvalues therebetween, especially including 50, 100, 150, 200, 250, 300, 350, 400, 450, 500 and 550 m²/g. The carbon black particles may have been subjected to oxidative post-treatment to obtain surface functionalities. They may be hydrophobic (for example PRINTEX 55 or FLAME BLACK 101 from Degussa) or hydrophilic (for example FW20 CARBON BLACK PIGMENT or PRINTEX 150 T from Degussa). They may have a high or low level of structuring; this describes the degree of aggregation of the primary particles. Specific conductive carbon blacks can be used to adjust the electrical conductivity of the components produced from the powder of the present invention. Better dispersibility in both the wet and the dry mixing processes can be utilized using carbon black in bead form. It can also be advantageous to use carbon black dispersions.

Animal charcoal is an inorganic black pigment comprising elemental carbon. It comprises from 70 to 90% of calcium phosphate and from 30 to 10% of carbon. Density is typically from 2.3 to 2.8 g/ml. The amount of calcium phosphate includes all values and subvalues therebetween, especially including 75, 80, and 85% by weight, based on the amount of charcoal. The amount of carbon includes all values and subvalues therebetween, especially including 15, 20, and 25% by weight based on the amount of charcoal. The density includes all values and subvalues therebetween, especially including 2.4, 2.5, 2.6, and 2.7 g/ml.

The absorber may also comprise a mixture of organic and/or inorganic pigments, of flame retardants or of other colorants, where each is intrinsically a poor absorber of electromagnetic radiation, but where their combination has sufficiently good absorption of the electromagnetic energy introduced to permit their use in the process of the present invention.

The absorber may be in pellet form or in powder form, for example. Depending on the process used to prepare the powder suitable for the process of the present invention, they may be subjected to grinding or post-grinding. If the use of a dispersion is advantageous for the preparation process, the absorber may by that stage be present in the form of a dispersion, or a dispersion may be prepared from fine absorber particles. The absorber may also take the form of a liquid. An example which may be mentioned here is CLEARWELD®.

These additives used here as absorber are obtainable, by way of example, from Merck with the name IRIODIN®. Carbon black means commercially available standard carbon blacks, such as those supplied by the companies Degussa AG, Cabot Corp., or Continental Carbon.

Commercially available examples of suitable absorbers in a general sense are IRIODIN® LS 820 or IRIODIN® LS 825, or IRIODIN® LS 850 from Merck. Examples which may be mentioned for the carbon black are PRINTEX 60, PRINTEX A, PRINTEX XE2, or PRINTEX ALPHA from Degussa. Degussa likewise supplies suitable CHP with the trade name VESTODUR FP-LAS.

The powder of the present invention may moreover comprise at least one auxiliary, at least one filler, and/or at least one pigment. By way of example, these auxiliaries may be powder-flow aids, e.g. fumed silicon dioxide or else precipitated silica. By way of example, filmed silicon dioxide (fumed silica) is supplied by Degussa AG with the product name AEROSIL®, with various specifications. The powder preferably comprises less than 3% by weight, preferably from 0.001 to 2% by weight, and very particularly preferably from 0.05 to 1% by weight, of these pigments, based on the entirety of the components, i.e. on the entirety comprising polymer and absorber. By way of example, the fillers may be glass particles, metal particles, in particular aluminum particles, or ceramic particles, e.g. solid or hollow glass beads, steel shot, aluminum shot, or granular metal, or else non-neutral pigments, e.g. transition metal oxides.

The median grain size of the filler particles is preferably smaller than or approximately equal to that of the particles of the polymers or of the polymer-encapsulated particles. The amount by which the median grain size d₅₀ of the fillers is below the median grain size d₅₀ of the polymers should preferably be not more than 20%, preferably not more than 15%, and very particularly preferably not more than 5%. A particular limit on the particle size arises via the permissible overall height or layer thickness in the particular apparatus used for the layer-by-layer process.

The powder of the present invention preferably comprises less than 75% by weight, with preference from 0.001 to 70% by weight, particularly preferably from 0.05 to 50% by weight, and very particularly preferably from 0.5 to 25% by weight, of these fillers, based on the entirety of the components, the proportion by volume of the polymers always therefore being greater than 50%. If coated particles are used, the proportion by volume of the polymers may also be smaller than 50%.

If the stated maxima for auxiliaries and/or fillers are exceeded, the result can, depending on the filler or auxiliary used, be marked impairment in the mechanical properties of moldings produced using these powders.

The powders of the present invention can be prepared easily and preferably by the process of the present invention for preparation of powder of the present invention, a feature of the process being that a PAEK powder is prepared, if appropriate the resultant grain fraction or grain shape is adapted for use in RP/RM processes, and furthermore, if appropriate, the material is treated with auxiliaries and additives, and, if necessary, is treated with an absorber. The list is not intended to anticipate the ideal sequence of the modifications used on the fundamental material. A dry blend method may be used to introduce the auxiliaries and additives, or the absorbers.

It can be advantageous when using a pulverulent absorber to treat the absorber first alone, or else the finished mixture, with a powder-flow aid, for example from Degussa's AEROSIL range, e.g. AEROSIL R972 or R812, or AEROSIL 200.

In this version of the process of the present invention, the powder may be a PAEK powder intrinsically suitable for rapid prototyping/rapid manufacturing processes, fine particles of the absorber simply being admixed therewith. The median grain size of the particles here is preferably smaller to at most approximately the same as that of the particles comprising polymer. The median grain size d₅₀ of the absorber should preferably be below the median grain size d₅₀ of the polymer powders by more than 20%, preferably by more than 50%, and very particularly preferably by more than 70%. A particular upper limit on the grain size is provided by the permissible overall height or layer thickness in the rapid prototyping/rapid manufacturing system. In particular, the median particle size of the absorber is from 0.001 to 50 μm, preferably from 0.02 to 10 μm. The median particle size includes all values and subvalues therebetween, especially including 0.005, 0.1, 0.5, 1, 5, 10, 15, 20, 25, 30, 35, 40 and 45 μm.

Very good distribution of the absorber is in particular provided via use of PAEK powders which feature a high BET surface area. From our own investigations we know that pigments distributed on a relatively smooth surface of particles whose BET surface area is below 1 m²/g lead to a severe reduction in the level of mechanical properties of the components produced therewith. In particular, tensile strain at break suffers from the preferential fracture sites provided by the pigment concentration on the surface. Surprisingly, it has now been found that the high BET surface area leads to good distribution of the absorber, thus permitting production of components with higher density and better mechanical properties, in particular tensile strain at break, if PAEK powder of the present invention is used in one of the processes described at an earlier stage above.

If appropriate, a suitable powder-flow aid, such as fumed aluminum oxide, fumed silicon dioxide, or fumed titanium dioxide, may be added externally to the precipitated or milled powder in order to improve powder-flow performance.

In the simplest embodiment of the process of the present invention, mixing at the fine particle level can be achieved, by way of example, via mixing in high-speed mechanical mixers to apply a finely powdered absorber to the dry powder.

Absorbers which may be used are commercially available products which, by way of example, can be purchased from Merck or Degussa with trademark IRIODIN® or PRINTEX®, or the products described above.

To improve processability or for further modification of the powder, the following materials may be added to the powder: inorganic pigments, in particular non-neutral pigments, e.g. transmission metal oxides, stabilizers, e.g. phenols, in particular sterically hindered phenols, flow agents and powder-flow aids, e.g. fumed silicas, and also filler particles. The amount of these substances added to the powders, based on the total weight of components in the powder, is preferably such as to comply with the concentration stated for fillers and/or auxiliaries for the powder of the present invention.

It can moreover be advantageous for the powder prepared to be a mixture which comprises not only the PAEK particles but also various fillers, e.g. glass particles, ceramic particles, or metal particles, or other additives, such as flame retardants. Examples of typical fillers are granular metals, such as granular aluminum, or steel shot, or glass beads.

The median particle size of the filler particles here is preferably smaller or approximately equal to that of the particles comprising PAEK. The median particle size d₅₀ of the filler should preferably be no more than 20%, preferably no more than 15%, and very particularly preferably no more than 5%, greater than the median particle size d₅₀ of the particles comprising PAEK. A particular limit on the particle size arises via the permissible overall height and layer thickness in an RP/RM apparatus suitable for processes described above (RP/RM processes). Glass beads whose median diameter is from 20 to 80 μm are typically used. Another preferred range is found at median particle sizes below 20 μm for the fillers or additives, preferably below 15 μm.

The present invention also provides the use of a powder for production of moldings in a layer-by-layer process which selectively melts the powder (rapid prototyping or rapid manufacturing process), in which powders of the present invention, which can also have been modified as described and/or can comprise an absorber, are used.

In particular, the present invention provides the use of the PAEK powder of the present invention, which also may have been modified as described and/or may comprise an absorber, for production of moldings via selective laser sintering.

Laser sintering processes are well known and are based on selective sintering of polymer particles, layers of polymer particles being briefly exposed to laser light, thus fusing the polymer particles exposed to the laser light. Successive sintering of layers of polymer particles produces three-dimensional objects. Details concerning the selective laser-sintering process are found by way of example in the specifications U.S. Pat. No. 6,136,948 and WO 96/06881. The wavelength of the CO₂ laser usually used here is 10 600 nm. However, the powder of the present invention can, in particular if it comprises an absorber, also be used in a process which uses a laser whose wavelength is from 100 to 3000 nm, preferably from 800 to 1070 nm, or from 1900 to 2100 nm, in particular in the process described above. The wavelength includes all values and subvalues therebetween, especially including 200, 400, 600, 800, 1000, 1200, 1400, 1600, 1800, 2000, 2200, 2400, 2600, and 2800 nm. The powder of the present invention can therefore in particular be used to produce moldings from powders via the SLS (selective laser sintering) process by means of lasers whose wavelength is 10 600 nm, and from 100 to 3000 nm, preferably from 800 to 1070 nm, or from 1900 to 2100 nm.

Laser energy with wavelengths of from 100 to 3000 nm can mostly be introduced without difficulty into an optical conductor. This can overcome the need for complicated mirror systems, if this optical conductor can then be guided in a flexible manner over the construction area. Lenses or mirrors can be used for further focusing of the laser beam. Cooling of the laser is not required in all instances.

To avoid curl, i.e. roll-up of the melted regions out of the plane of construction, it is useful to heat the construction chamber. Heating preferably takes place to a temperature just below the melting point of the polymer. The process parameters can easily be discovered via appropriate preliminary trials, depending on the process. For the PAEK powders of the present invention it is advantageous to use a non-aggressive method of introducing the energy needed for melting.

A feature of the moldings of the present invention, produced via a process for layer-by-layer construction of three-dimensional articles in which regions of a powder layer, in particular of the powder of the present invention, are selectively melted via exposure to electromagnetic radiation, e.g. selective laser-sintering, is that they comprise PAEK. They particularly preferably comprise a PEEK, PEK, PEKK, or a PEEKK.

The absorber present if appropriate in the molding of the present invention can by way of example comprise what is known as a colorant. A colorant means any of the colorant substances to DIN 55944 which are divisible into inorganic and organic colorants, and also into natural and synthetic colorants (see Römpps Chemielexikon [Römpp's Chemical Encyclopedia], 1981, 8th edition, p. 1237). According to DIN 55943 (September 1984) and DIN 55945 (August 1983), a pigment is an inorganic or organic colorant whose color is non-neutral or neutral and which is practically insoluble in the medium in which it is used. Dyes are inorganic or organic colorants whose color is non-neutral or neutral and which are soluble in solvents and/or in binders.

However, the absorber present if appropriate in the molding of the present invention may also gain its absorbent action by comprising additives. By way of example, these may be flame retardants based on melamine cyanurate (MELAPUR from DSM) or based on phosphorus, preference being given to phosphates, phosphites, phosphonites, or elemental red phosphorus. Other suitable additives are carbon fibers, preferably ground, glass beads, including hollow beads, or kaolin, chalk, wollastonite, or graphite.

The absorber present if appropriate in the molding of the present invention preferably comprises carbon black or CHP (copper hydroxide phosphate), or chalk, animal charcoal, carbon fibers, graphite, flame retardant, or interference pigments as principal component. Interference pigments are what are known as pearl-luster pigments. Using the natural mineral mica as a basis, they are encapsulated with a thin layer comprising metal oxides, such as titanium dioxide and/or iron oxide, and are available with a median grain size distribution of from 1 to 60 μm. By way of example, interference pigments are supplied by Merck with the name IRIODIN. The IRIODIN product line from Merck encompasses pearl-luster pigments and metal-oxide-coated mica pigments, and also the subclasses of: interference pigments, metallic-luster special-effect pigments (iron oxide coating on the mica core), silver special-effect pigments, gold-luster special-effect pigments (mica core coated with titanium dioxide and with iron oxide). The use of IRIODIN grades in the IRIODIN LS series is particularly preferred, namely IRIODIN LS 820, IRIODIN LS 825, IRIODIN LS 830, IRIODIN LS 835, and IRIODIN LS 850. The use of IRIODIN LS 820 and IRIODIN LS 825 is very particularly preferred.

The absorber present if appropriate in the molding of the present invention can by way of example comprise: mica or mica pigments, titanium dioxide, kaolin, organic and inorganic color pigments, antimony(III) oxide, metal pigments, pigments based on bismuth oxychloride (e.g. the BIFLAIR series from Merck, high-luster pigment), indium tin oxide (nano-ITO powder from Nanogate Technologies GmbH or Adnano™ ITO from Degussa), ADNANO™ ZINC OXIDE (Degussa), lanthanum hexachloride, CLEARWELD® (WO 0238677), and also commercially available flame retardants which comprise melamine cyanurate or comprise phosphorus, preferably comprising phosphates, phosphites, phosphonites, or elemental (red) phosphorus.

The amount of absorber present in the molding of the present invention, based on the entirety of the components present in the molding, is preferably from 0.01 to 30% by weight, with preference from 0.05 to 20% by weight, particularly preferably from 0.2 to 15% by weight, and very particularly preferably from 0.4 to 10% by weight. The amount of absorber includes all values and subvalues therebetween, especially including 0.05, 0.1, 0.5, 1, 5, 10, 15, 20, and 25 wt %. The proportion of adsorber is at most 50% by weight, based on the entirety of the components present in the molding.

The moldings may comprise fillers and/or auxiliaries and/or pigments alongside polymer and absorber, examples being heat stabilizers and/or oxidation stabilizers, e.g. sterically hindered phenol derivatives. Fillers may by way of example be glass particles, ceramic particles, and also metal particles, such as iron shot, or appropriate hollow beads. The moldings of the present invention preferably comprise glass particles, very particularly preferably glass beads. Moldings of the present invention preferably comprise less than 3% by weight, preferably from 0.001 to 2% by weight, and very particularly preferably from 0.05 to 1% by weight, of these auxiliaries, based on the entirety of the components present. Moldings of the present invention likewise preferably comprise less than 75% by weight, preferably from 0.001 to 70% by weight, particularly preferably from 0.05 to 50% by weight, and very particularly preferably from 0.5 to 25% by weight, of these fillers, based on the entirety of the components present.

Application sectors for these moldings are found not only in rapid prototyping but also in rapid manufacturing. The latter always means short runs, i.e. production of more than one identical part, for which however, production by means of an injection mold is uneconomic. Examples of these are parts for high-specification cars, of which only small numbers are produced, or replacement parts for motor sports, for which availability time is a factor alongside the small numbers. Examples of areas where the parts of the present invention are used may be the aerospace industry, medical technology, mechanical engineering, automobile construction, the sports industry, the household goods industry, the electrical industry, and the lifestyle sector.

The present invention relates to a powder comprising PAEK, to the use of this powder in processes whose operation is based on pulverulent materials and in which the desired structures are produced layer-by-layer via selective melting and hardening, and also to moldings produced from this powder by this process. The moldings of the present invention when compared with moldings produced by conventional laser-sintering processes, exhibit marked advantages in relation to their heat resistance and their mechanical properties. This can open up new applications by means of RP/RM (rapid prototyping/rapid manufacturing) processes, for example in the engine compartment of a car.

Having generally described this invention, a further understanding can be obtained by reference to certain specific examples which are provided herein for purposes of illustration only, and are not intended to be limiting unless otherwise specified.

### EXAMPLES

The determination of BET surface area carried out in the examples below complied with DIN 66 131. Bulk density was determined using an apparatus to DIN 53 466. The values measured for laser diffraction were obtained on a MALVERN MASTERSIZER S, Ver. 2.18.

### Preparation of PEEK Powder of the Present Invention, Example 1

Particles comprising PEEK whose BET surface area was 50 m²/g and whose median grain diameter was 500 μm were milled with the aid of a cryogenic pinned-disk mill (HOSOKAWA ALPINE CW 160). The PEEK particles here were conveyed by way of a conveying screw into a milling chamber and during this process were cooled by liquid nitrogen to −50° C. In this milling chamber, the PEEK particles were accelerated to 220 m/s via rotating pinned disks. They impacted the pins attached to the pinned disks with this velocity and were thus exposed to severe impact stress, which fractured the particles. The throughput of PEEK particles in this process was 15 kg/h. The product discharged from the milling chamber was a micronized product, its fraction of particles smaller than 100 μm being 30% by weight (sieve analysis using Alpine air-jet sieve to DIN EN ISO 4610).

Micronization was followed by the separation particle process. In this, the comminuted PEEK particles were fractionated with the aid of an Alpine air-jet sieve with downstream cyclone. The mesh width used during fractionation was 80 μm. The resultant powder was characterized by d₁₀ of 16.7 μm, d₅₀ of 52.6 μm, and d₉₀ of 113.8 μm.

### Example 2

### PEEK Powder with Powder-Flow Aid

3.8 g of AEROSIL 200 (0.2 part) were incorporated by mixing into 1900 g (100 parts) of PEEK powder prepared as in example 1, whose median grain diameter d₅₀ was 52.6 μm (laser diffraction) by the dry-blend method utilizing a FML10/KM23 HENSCHEL MIXER at room temperature and 500 rpm over a period of 3 minutes. The bulk density measured on the finished powder was 493 g/l to DIN 53 466. The BET surface area was 22.3 m²/g.

### Example 3

### PEEK Powder with IRIODIN® LS 825

19 g (1 part) of IRIODIN® LS 825 were incorporated by mixing into 1900 g (100 parts) of PEEK powder prepared as in example 1, whose median grain diameter d₅₀ was 52.6 μm (laser diffraction) by the dry-blend method utilizing a FML10/KM23 HENSCHEL MIXER at 500 rpm at 40° C. over a period of 2 minutes. 3.8 g of AEROSIL 200 (0.2 part) were then incorporated by mixing at room temperature and 500 rpm over a period of 3 minutes. The bulk density measured on the finished powder was 471 g/l to DIN 53 466. The BET surface area was 22.3 m²/g.

### Example 4

### PEEK Powder with PRINTEX ALPHA

47 g (2.5 parts) of PRINTEX ALPHA were incorporated by mixing into 1900 g (100 parts) of PEEK powder prepared as in example 1, whose median grain diameter d₅₀ was 52.6 μm (laser diffraction) by the dry-blend method utilizing a FML10/KM23 HENSCHEL MIXER at 700 rpm at 50° C. over a period of 2 minutes. 1.0 g of AEROSIL R812 (0.05 part) were then incorporated by mixing at room temperature and 500 rpm over a period of 2 minutes. The bulk density measured on the finished powder was 450 g/l to DIN 53 466. The BET surface area was 22.3 m²/g.

### Example 5

### VICTREX 450 G PEEK Powder Milled (Comparative)

Product sold by Victrex; the pellets were ground in a HOSOKAWA. ALPINE CW 160 pinned-disk mill. The temperature in the process was −65° C., but the yield did not exceed about 3%. The BET surface area of the initial pellets was less than 0.1 m²/g.

After precautionary 120 μm sieving, 2.0 g of AEROSIL 200 (0.1 part) were incorporated by mixing at room temperature and 500 rpm over a period of 2 minutes. The median grain diameter was determined as 98 μm by means of laser diffraction. Bulk density measured on the finished powder was 499 g/l to DIN 53 466. The BET surface area of the powder was less than 0.1 m²/g.

### Example 6

### Processing in an Apparatus Using Nd:YAG Laser

An open-topped box, 10×10 cm, was provided with a base which can be moved by way of a spindle. The base was moved to a position half a centimeter from the upper edge; the remaining space was filled with powder, which was smoothed using a metal plate. The apparatus was placed in the construction chamber of a STAR MARK 65 Nd:YAG laser (producer: Carl Basel Lasertechnik). The laser melted an area of width 4 mm and length 20 mm.

The next steps were repeated a number of times: rotation of the spindle to lower the base by 0.15 mm and application of the next powder layer, smoothing, and then another irradiation of the area of width 4 mm and length 20 mm by the Nd:YAG laser to melt the powder.

The powder not treated with absorber from examples 2 and 5 exhibited poor melting. However, plaques with the desired shape could be produced using the powders from examples 3 and 4.

However, there remained a need to optimize in particular the temperature profile, because curl occurred as a result of the non-automated handling and application of cold absorber.

### Example 7

### Processing in an EOSINT P 360

The powders from examples 2-5 were tested in the laser-sintering machine from the producer EOS GmbH, Krailling, Germany. The maximum possible construction chamber temperature of about 200° C. was used.

The powder from example 5 had no processing latitude. Although the maximum possible amount of energy was introduced, the result was not a smooth melt film but instead a pimply surface on which it was still possible to discern the individual grains. It was impossible to apply a second layer because severe curl occurred at the edges of the film, i.e. roll-up of the edges out of the plane of construction. When the laser power was raised toward the maximum value for the 50 watt laser the result was ash particles which deposited on the construction platform.

The powder from example 2 could be processed, but the resultant plaque had a relatively large number of cavities, giving low densities.

The powders from examples 3 and 4 were processable and produced substantially denser components than the powder from example 2.

| | Density [g/l] |
|---|---|
| Component comprising powder from example 2 | 0.91 |
| Component comprising powder from example 3 | 1.1 |
| Component comprising powder from example 4 | 1.21 |

The heat resistances to DIN 53461, HDT/B of the components from examples 3 and 4 were 218 and, respectively, 221° C. The heat resistance of a laser-sintered component comprising the standard material EOSINT P2200 GF was 140° C.

German patent application 10 2004 062761.4 filed Dec. 21, 2004, and all patents and publications mentioned herein are incorporated herein by reference.

Numerous modifications and variations on the present invention are possible in light of the above teachings. It is therefore to be understood that within the scope of the appended claims, the invention may be practiced otherwise than as specifically described herein.

1. A polymer powder, comprising:
polyarylene ether ketone;
wherein said powder has a BET surface area of from 1 to 60 m²/g; and
wherein said powder is suitable for use in a layer-by-layer process in which regions of a powder layer are selectively melted via introduction of electromagnetic energy.

2. The polymer powder according to claim 1, having a BET surface area of from 5 to 45 m²/g.

3. The polymer powder according to claim 1, having a BET surface area of from 15 to 40 m²/g.

4. The polymer powder according to claim 1, comprising at least one polymer selected from the group consisting of a second polyether ether ketone, polyether ketone, polyether ketone ketone, polyether ether ketone ketone and mixtures thereof.

5. The polymer powder according to claim 1, having a median grain diameter of from 30 to 150 μm.

6. The polymer powder according to claim 1, having a median grain diameter of from 45 to 120 μm.

7. The polymer powder according to claim 1, having a median grain diameter of from 48 to 100 μm.

8. The polymer powder according to claim 1, having a solution viscosity in 96% strength sulfuric acid according to EN ISO 1628-1, or based on DIN EN ISO 307, of from 0.2 to 1.3.

9. The polymer powder according to claim 1 having a solution viscosity in 96% strength sulfuric acid according to EN ISO 1628-1, or based on DIN EN ISO 307, of from 0.5 to 1.1.

10. The polymer powder according to claim 1, wherein a component produced from said powder has a solution viscosity in 96% strength sulfuric acid according to EN ISO 1628-1, or based on DIN EN ISO 307, which is higher than or equal to the solution viscosity of the powder.

11. The polymer powder according to claim 1, further comprising:
at least one member selected from the group consisting of an auxiliary, a filler, a pigment, an absorber and mixtures thereof.

12. The polymer powder according to claim 11, comprising a powder-flow aid as auxiliary.

13. The polymer powder according to claim 11, wherein the absorber comprises a colorant.

14. The polymer powder according to claim 13, wherein the absorber comprises a dye.

15. The polymer powder according to claim 13, wherein the absorber comprises a pigment.

16. The polymer powder according to claim 11, wherein the absorber comprises at least one member selected from the group consisting of carbon black, CHP, animal charcoal, graphite, carbon fibers, chalk, interference pigments and mixtures thereof.

17. The polymer powder according to claim 11, wherein the absorber comprises other components.

18. The polymer powder according to claim 11, wherein the absorber comprises flame retardants based on phosphorus or melamine cyanurate.

19. The polymer powder according to claim 11, which comprises the absorber component in powder form with a median particle size of from 0.001 to 50 μm.

20. The polymer powder according to claim 1, which comprises, based on the entirety of the polymers present in the powder, from 0.01 to 30% by weight of an absorber.

21. The polymer powder according to claim 1, which comprises, based on the entirety of the polymers present in the powder, from 0.05 to 20% by weight of an absorber.

22. The polymer powder according to claim 1, which comprises, based on the entirety of the polymers present in the powder, from 0.2 to 15% by weight of an absorber.

23. The polymer powder according to claim 1, which comprises, based on the entirety of the polymers present in the powder, from 0.4 to 10% by weight of an absorber.

24. The polymer powder according to claim 1, comprising a mixture of carbon black particles and polymer particles.

25. The polymer powder according to claim 24, wherein the carbon black particles have been hydrophilicized.

26. The polymer powder according to claim 24, wherein the carbon black particles have been hydrophobicized.

27. The polymer powder according to claim 1, which comprises at least one member selected from the group consisting of granular aluminum particles, glass particles and mixtures thereof.

28. A process for preparation of a polymer powder composition, comprising:
mixing at least one polymer powder according to claim 1 with an absorber.

29. A process for production of a molding, comprising:
selectively melting regions of a layer of the polymer powder according to claim 1 via introduction of electromagnetic energy.

30. The process according to claim 29, wherein the selectivity is achieved via application of at least one member selected from the group consisting of an inhibitor, a susceptor, an absorber, a mask and combinations thereof.

31. The process according to claim 29, comprising selective laser sintering of the polymer powder.

32. The process according to claim 29, comprising infrared heating of the polymer powder to melt the polymer powder.

33. The process according to claim 29, comprising melting the polymer powder by using a microwave generator.

34. A molding, obtained by the process of claim 29.

35. The molding according to claim 34, which comprises at least one polymer selected from the group consisting of a second polyether ether ketone, polyether ketone, polyether ketone ketone, polyether ether ketone ketone and mixtures thereof.

36. The molding according to claim 34, comprising from 0.01 to 30% by weight of absorber, based on the entirety of the polymers present.

37. The molding according to claim 34, which comprises a colorant.

38. The molding according to claim 37, which comprises a dye.

39. The molding according to claim 37, which comprises a pigment.

40. The molding according to claim 34, which comprises at least one member selected from the group consisting of carbon black, CHP, animal charcoal, graphite, carbon fibers, chalk, interference pigments, flame retardants based on phosphorus or on melamine cyanurate and mixtures thereof.

41. The molding according to claim 34, which comprises at least one member selected from the group consisting of a filler, an auxiliary and mixtures thereof.

42. The molding according to claim 34, which is a molding for the aerospace industry, a molding for automobile construction, a molding for mechanical engineering, a molding for medical technology, a molding for sports industry, a molding for electronics industry, a molding for household goods industry, or a molding for lifestyle sector.
